(19) United States
(12) Patent Application Publication
(10) Pub. No.: US 2006/0173635 A1
(43) Pub. Date: Aug. 3, 2006

(54) Analyzing and visualizing enrichment in DNA sequence alterations

(76) Inventors: Zohar H. Yakhini, Loveland, CO (US); Amir Ben-Dor, Bellevue, WA (US); Anya Tsalenko, Chicago, IL (US); Doron Lipson, Tel-Aviv (IL)

Correspondence Address: AGILENT TECHNOLOGIES, INC.;INTELLECTUAL PROPERTY ADMINISTRATION, LEGAL DEPT., P.O. BOX 7599, M/S DL429, LOVELAND, CO, 80537-0599, US

(21) Appl. No.: 11/049,565

(22) Filed: Feb. 1, 2005

(51) Int. Cl. G06F 19/00

(52) U.S. Cl. 702/20

(57) ABSTRACT

Methods, tools, systems and computer readable media for analyzing CGH data, together with data from an independent source. Independent data is compared with the CGH data, wherein the CGH data is characterized by sets of defined regions differentiated by at least one property. Enrichment is assessed for at least one subset of the data from an independent source with regard to at least one of the sets of defined regions in the CGH data. Methods, tools, systems and computer readable media for visualizing CGH data as it is impacted by data from an independent source are also provided. A relationship between at least one defined set of the CGH data and at least one set of sequence elements defined in the data from an independent source may be visualized.

### BACKGROUND OF THE INVENTION

Many genomic and genetic studies are directed to the identification of differences in gene dosage or expression among cell populations for the study and detection of disease. For example, many malignancies involve the gain or loss of DNA sequences (alterations in copy number), sometimes entire chromosomes, that may result in activation of oncogenes or inactivation of tumor suppressor genes. Identification of the genetic events leading to neoplastic transformation and subsequent progression can facilitate efforts to define the biological basis for disease, improve prognostication of therapeutic response, and permit earlier tumor detection. In addition, perinatal genetic problems frequently result from loss or gain of chromosome segments such as trisomy 21 or the micro deletion syndromes. Trisomy of chromosome 13 results in Patau syndrome. Abnormal numbers of sex chromosomes result in various developmental disorders. Thus, methods of prenatal detection of such abnormalities can be helpful in early diagnosis of disease.

Comparative genomic hybridization (CGH) is a technique that is used to evaluate variations in genomic copy number in cells. In one implementation of CGH, genomic DNA is isolated from normal reference cells, as well as from test cells (e.g., tumor cells). The two nucleic acids are differentially labeled and then simultaneously hybridized in situ to metaphase chromosomes of a reference cell. Chromosomal regions in the test cells which are at increased or decreased copy number can be identified by detecting regions where the ratio of signal from the two distinguishably labeled nucleic acids is altered. For example, those regions that have been decreased in copy number in the test cells will show relatively lower signal form the test DNA that the reference, compared to other regions of the genome. Regions that have been increased in copy number in the test cells will show relatively higher signal from the test DNA.

A recent technology development introduced an oligonucleotide array platform for array based comparative genomic hybridization (aCGH) analyses. Such approaches offer benefits over immobilized chromosome approaches, including a higher resolution, as defined by the ability of the assay to localize chromosomal alterations to specific areas of the genome. For further detailed description regarding aCGH technology, the reader is referred to co-pending application Ser. No. 10/744,495 filed Dec. 22, 2003 and titled “Comparative Genomic Hybridization Assays Using Immobilized Oligonucleotide Features and Compositions for Practicing the Same”, which is incorporated herein, in its entirety, by reference thereto.

One of the advantages of the aCGH platform described in application Ser. No. 10/744,495, is that oligonucleotide probes can be designed in silico for any sequenced region, coding and non-coding), of a genome of interest. This allows increased potential in the design and optimization of probes compared to existing CGH formats such as BAC arrays. Such platform also allows custom design of arrays, including high-density region-specific content at high probe densities. The above technology advantages lead to increased resolution in determining the boundaries of measured genome alterations, up to a theoretical limit of single 60 mer probes. Results of calling aberrations measured by aCGH are exemplified in 4, where genomic aberrations were identified in breast tumor samples based on data presented by Pollack et al., “Microarray analysis reveals a major direct role of DNA copy number alteration in the transcriptional program of human breast tumors”, PNAS, 99(2):12963-8, which is incorporated herein, in its entirety, by reference thereto. In the representation shown in FIG. 4, the small dots 10b represent all probed positions, while the larger indicators 12r represent locations of significant amplification and the larger indicators 14g indicate locations of significant deletions. Typically, the indicators will be color-coded, e.g., 10b may be color-coded blue, 12r may be color coded red and 14g may be color-coded green. To further interpret and understand the meaning of aberrations discovered using CGH measurement technologies investigators are interested in understanding the genomic content of aberrant regions. Thus there is a continuing need for new methods and tools for further identifying the genomic content of aberrant regions and for analyzing such content and statistically assessing to further knowledge regarding disease causation and/or roles that particular genes and/or groups of genes may play in particular diseases, syndromes or other genetically related maladies.

Co-pending application Ser. No. 10/817,244, filed Apr. 3, 2004 and titled “Visualizing Expression Data on Chromosome Graphic Schemes” describes the display of gene- and/or protein related data with respect to chromosome maps at locations identifying the relative positions of genes that the data represents, on the chromosomes. application Ser. No. 10/817,24 is hereby incorporated herein, in its entirety, by reference thereto.

Co-pending application Ser. No. 10/964,207 filed Oct. 12, 2004 and titled “Methods and Systems for Joint Analysis of Array CGH Data and Gene Expression Data” may identify a high-scoring significantly altered genomic-continuous submatrix, wherein each genomic-continuous submatrix contains a subset of a set of genes measure across a set of samples to generate a DNA copy number data matrix and a gene expression matrix. application Ser. No. 10/964,207 is hereby incorporated herein, in its entirety, by reference thereto.

Co-pending application Ser. No. 10/964,524 filed Oct. 12, 2004 and titled “Systems and Methods for Statistically Analyzing Apparent CGH Data Anomalies and Plotting Same” statistically analyzing apparent anomalies in CGH data by ordering the CGH data corresponding to locations of matter on chromosomes from which the CGH data was derived. A set of CGH ratio values is considered and Z-score values are computed for each CGH ratio value. The Z-score values are classified based upon a predetermined cutoff value. The number of Z-scores that are greater than the predetermined cutoff value are counted, the number of Z-scores that are less than a negative of the predetermined cutoff value are counted, and the total number of Z-scores are counted. A subset of the set of CGH ratios are considered, being defined by a window of predetermined size. A secondary Z-score is computed to measure the significance of at least one of overabundance and underabundance of at least one of significant positive deviations and significant negative deviations in the subset. application Ser. No. 10/964,524 is hereby incorporated herein, in its entirety, by reference thereto.

There is a continuing need to understand the genomic content of aberrant regions, to further interpret and understand the meaning of aberrations discovered using CGH measurement technologies. Procedures, techniques and instrumentation are needed to understand the genomic content of aberrant regions identified by CGH techniques for further use in studying diseases and conditions and potential links to such aberrant regions.

### SUMMARY OF THE INVENTION

Methods, systems and tools for analyzing CGH data, together with data from an independent source are provided for comparing the independent data with the CGH data, wherein the CGH data is characterized by sets of defined regions, where the sets are differentiated by at least one property; and assessing enrichment of at least one subset of the data from an independent source with regard to at least one of the sets of defined regions.

Methods, tools and systems for visualizing CGH data as it is impacted by data from an independent source, are provided for visualizing a relationship between at least one defined set of the CGH data and at least one set of sequence elements defined in the data from an independent source.

These and other advantages and features of the invention will become apparent to those persons skilled in the art upon reading the details of the methods, tools, systems and computer readable media as more fully described below.

### BRIEF DESCRIPTION OF THE DRAWINGS

FIG., 1 shows an exemplary substrate carrying an array, such as may be used in the devices of the subject invention.

FIG. 2 shows an enlarged view of a portion of FIG. 1 showing spots or features.

FIG. 3 is an enlarged view of a portion of the substrate of FIG. 1.

FIG. 4 shows a visualization of aCGH data analyzed to call out aberrant regions, that are visually displayed with regard to the chromosomes on which they occur, along with regions that have not been amplified or deleted (“non-aberrant regions”).

FIG. 5 is a schematic representation of a user interface implementing a tool configured to graphically output calculated enrichment results.

FIG. 6 is a schematic representation similar to FIG. 5, also showing additional plots having been graphically outputted.

FIG. 7A shows a graphical output including a GO tree annotated with enrichment results.

FIG. 7B shows a partial view of a graphical output including a GO tree annotated with enrichment results.

FIG. 7C shows a partial view of another graphical output including a GO tree annotated with enrichment results.

FIG. 8A shows a visualization of aCGH data analyzed to call out aberrant regions, that are visually displayed with regard to two chromosomes on which they occur, along with regions that have not been amplified or deleted (“non-aberrant regions”), in addition to tracks that graphically display members of an independent set of data in locations adjacent to where they occur on the chromosomes that the CGH data is represented on.

FIG. 8B shows an aberration summary plot as well as a plot of significance of differential expression genes, with respect to chromosome 1, relative to breast cancer studies that were conducted.

FIG. 9 illustrates a typical computer system that may be used to practice an embodiment of the present invention.

### DETAILED DESCRIPTION OF THE INVENTION

Before the present methods, systems and computer readable media are described, it is to be understood that this invention is not limited to particular data, algorithms, samples, hardware or software described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed within the invention. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods and materials are now described. All publications mentioned herein are incorporated herein by reference to disclose and describe the methods and/or materials in connection with which the publications are cited.

It must be noted that as used herein and in the appended claims, the singular forms “a”, “and”, and “the” include plural referents unless the context clearly dictates otherwise. Thus, for example, reference to “a gene” includes a plurality of such genes and reference to “the sample” includes reference to one or more samples and equivalents thereof known to those skilled in the art, and so forth.

The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates which may need to be independently confirmed.

Definitions

An “aberrant region” refers to an uninterrupted section of a chromosome which has been identified to show significant amplification or deletion of genetic material.

The term “enrichment” refers to over-representation of a set of objects having a given property within another set of objects having another property. For example, an aberrant region of a chromosome is considered to be enriched when a proportion of known, cancer-related genes, located in that aberrant region, is significantly greater than a proportion of those known, cancer-related genes located outside of that aberrant region.

The term “motif” or “sequence motif” refers to a nucleotide or amino-acid sequence pattern that is widespread and has, or is conjectured to have, a biological significance. A motif is often inferred from a DNA sequence.

“Binary data as used herein, refers to a binary representation of set membership. Thus, for example, a member is assigned a value of “1” if it belongs to the set being considered, and a member is assigned a value of “0” if it does not belong to the set being considered, or vice versa.

The term “oligomer” is used herein to indicate a chemical entity that contains a plurality of monomers. As used herein, the terms “oligomer” and “polymer” are used interchangeably. Examples of oligomers and polymers include polydeoxyribonucleotides (DNA), polyribonucleotides (RNA), other nucleic acids that are C-glycosides of a purine or pyrimidine base, polypeptides (proteins) or polysaccharides (starches, or polysugars), as well as other chemical entities that contain repeating units of like chemical structure.

The term “nucleic acid” as used herein means a polymer composed of nucleotides, e.g., deoxyribonucleotides or ribonucleotides, or compounds produced synthetically (e.g., PNA as described in U.S. Pat. No. 5,948,902 and the references cited therein) which can hybridize with naturally occurring nucleic acids in a sequence specific manner analogous to that of two naturally occurring nucleic acids, e.g., can participate in Watson-Crick base pairing interactions.

The terms “ribonucleic acid” and “RNA” as used herein mean a polymer composed of ribonucleotides.

The terms “deoxyribonucleic acid” and “DNA” as used herein mean a polymer composed of deoxyribonucleotides.

The term “oligonucleotide” as used herein denotes single stranded nucleotide multimers of from about 10 to 100 nucleotides and up to 200 nucleotides in length.

The term “functionalization” as used herein relates to modification of a solid substrate to provide a plurality of functional groups on the substrate surface. By a “functionalized surface” is meant a substrate surface that has been modified so that a plurality of functional groups are present thereon.

The terms “reactive site”, “reactive functional group” or “reactive group” refer to moieties on a monomer, polymer or substrate surface that may be used as the starting point in a synthetic organic process. This is contrasted to “inert” hydrophilic groups that could also be present on a substrate surface, e.g., hydrophilic sites associated with polyethylene glycol, a polyamide or the like.

The term “sample” as used herein relates to a material or mixture of materials, typically, although not necessarily, in fluid form, containing one or more components of interest.

The terms “nucleoside” and “nucleotide” are intended to include those moieties that contain not only the known purine and pyrimidine bases, but also other heterocyclic bases that have been modified. Such modifications include methylated purines or pyrimidines, acylated purines or pyrimidines, alkylated riboses or other heterocycles. In addition, the terms “nucleoside” and “nucleotide” include those moieties that contain not only conventional ribose and deoxyribose sugars, but other sugars as well. Modified nucleosides or nucleotides also include modifications on the sugar moiety, e.g., wherein one or more of the hydroxyl groups are replaced with halogen atoms or aliphatic groups, or are functionalized as ethers, amines, or the like.

The phrase “oligonucleotide bound to a surface of a solid support” refers to an oligonucleotide or mimetic thereof, e.g., PNA, that is immobilized on a surface of a solid substrate in a feature or spot, where the substrate can have a variety of configurations, e.g., a sheet, bead, or other structure. In certain embodiments, the collections of features of oligonucleotides employed herein are present on a surface of the same planar support, e.g., in the form of an array.

The term “array” encompasses the term “microarray” and refers to an ordered array presented for binding to nucleic acids and the like. Arrays, as described in greater detail below, are generally made up of a plurality of distinct or different features. The term “feature” is used interchangeably herein with the terms: “features,” “feature elements,” “spots,” “addressable regions,” “regions of different moieties,” “surface or substrate immobilized elements” and “array elements,” where each feature is made up of oligonucleotides bound to a surface of a solid support, also referred to as substrate immobilized nucleic acids.

An “array,” includes any one-dimensional, two-dimensional or substantially two-dimensional (as well as a three-dimensional) arrangement of addressable regions (i.e., features, e.g., in the form of spots) bearing nucleic acids, particularly oligonucleotides or synthetic mimetics thereof (i.e., the oligonucleotides defined above), and the like. Where the arrays are arrays of nucleic acids, the nucleic acids may be adsorbed, physisorbed, chemisorbed, or covalently attached to the arrays at any point or points along the nucleic acid chain.

Any given substrate may carry one, two, four or more arrays disposed on a front surface of the substrate. Depending upon the use, any or all of the arrays may be the same or different from one another and each may contain multiple spots or features. A typical array may contain one or more, including more than two, more than ten, more than one hundred, more than one thousand, more ten thousand features, or even more than one hundred thousand features, in an area of less than 20 cm² or even less than 10 cm², e.g., less than about 5 cm², including less than about 1 cm², less than about 1 mm², e.g., 100μ², or even smaller. For example, features may have widths (that is, diameter, for a round spot) in the range from a 10 μm to 1.0 cm. In other embodiments each feature may have a width in the range of 1.0 μm to 1.0 mm, usually 5.0 μm to 500 μm, and more usually 10 μm to 200 μm. Non-round features may have area ranges equivalent to that of circular features with the foregoing width (diameter) ranges. At least some, or all, of the features are of different compositions (for example, when any repeats of each feature composition are excluded the remaining features may account for at least 5%, 10%, 20%, 50%, 95%, 99% or 100% of the total number of features). Inter-feature areas will typically (but not essentially) be present which do not carry any nucleic acids (or other biopolymer or chemical moiety of a type of which the features are composed). Such inter-feature areas typically will be present where the arrays are formed by processes involving drop deposition of reagents but may not be present when, for example, photolithographic array fabrication processes are used. It will be appreciated though, that the inter-feature areas, when present, could be of various sizes and configurations.

Each array may cover an area of less than 200 cm², or even less than 50 cm², 5 cm², 1 cm², 0.5 cm², or 0.1 cm². In certain embodiments, the substrate carrying the one or more arrays will be shaped generally as a rectangular solid (although other shapes are possible), having a length of more than 4 mm and less than 150 mm, usually more than 4 mm and less than 80 mm, more usually less than 20 mm; a width of more than 4 mm and less than 150 mm, usually less than 80 mm and more usually less than 20 mm; and a thickness of more than 0.01 mm and less than 5.0 mm, usually more than 0.1 mm and less than 2 mm and more usually more than 0.2 and less than 1.5 mm, such as more than about 0.8 mm and less than about 1.2 mm. With arrays that are read by detecting fluorescence, the substrate may be of a material that emits low fluorescence upon illumination with the excitation light. Additionally in this situation, the substrate may be relatively transparent to reduce the absorption of the incident illuminating laser light and subsequent heating if the focused laser beam travels too slowly over a region. For example, the substrate may transmit at least 20%, or 50% (or even at least 70%, 90%, or 95%), of the illuminating light incident on the front as may be measured across the entire integrated spectrum of such illuminating light or alternatively at 532 nm or 633 nm.

Arrays can be fabricated using drop deposition from pulse-jets of either nucleic acid precursor units (such as monomers) in the case of in situ fabrication, or the previously obtained nucleic acid. Such methods are described in detail in, for example, the previously cited references including U.S. Pat. No. 6,242,266, U.S. Pat. No. 6,232,072, U.S. Pat. No. 6,180,351, U.S. Pat. No. 6,171,797, U.S. Pat. No. 6,323,043, U.S. patent application Ser. No. 09/302,898 filed Apr. 30, 1999 by Caren et al., and the references cited therein. As already mentioned, these references are incorporated herein by reference. Other drop deposition methods can be used for fabrication, as previously described herein. Also, instead of drop deposition methods, photolithographic array fabrication methods may be used. Inter-feature areas need not be present particularly when the arrays are made by photolithographic methods as described in those patents.

In certain embodiments of particular interest, in situ prepared arrays are employed. In situ prepared oligonucleotide arrays, e.g., nucleic acid arrays, may be characterized by having surface properties of the substrate that differ significantly between the feature and inter-feature areas. Specifically, such arrays may have high surface energy, hydrophilic features and hydrophobic, low surface energy hydrophobic interfeature regions. Whether a given region, e.g., feature or interfeature region, of a substrate has a high or low surface energy can be readily determined by determining the regions “contact angle” with water, as known in the art and further described in co-pending application Ser. No. 10/449,838, the disclosure of which is herein incorporated by reference. Other features of in situ prepared arrays that make such array formats of particular interest in certain embodiments of the present invention include, but are not limited to: feature density, oligonucleotide density within each feature, feature uniformity, low intra-feature background, low inter-feature background, e.g., due to hydrophobic interfeature regions, fidelity of oligonucleotide elements making up the individual features, array/feature reproducibility, and the like. The above benefits of in situ produced arrays assist in maintaining adequate sensitivity while operating under stringency conditions required to accommodate highly complex samples.

An array is “addressable” when it has multiple regions of different moieties, i.e., features (e.g., each made up of different oligonucleotide sequences) such that a region (i.e., a “feature” or “spot” of the array) at a particular predetermined location (i.e., an “address”) on the array will detect a particular solution phase nucleic acid sequence. Array features are typically, but need not be, separated by intervening spaces.

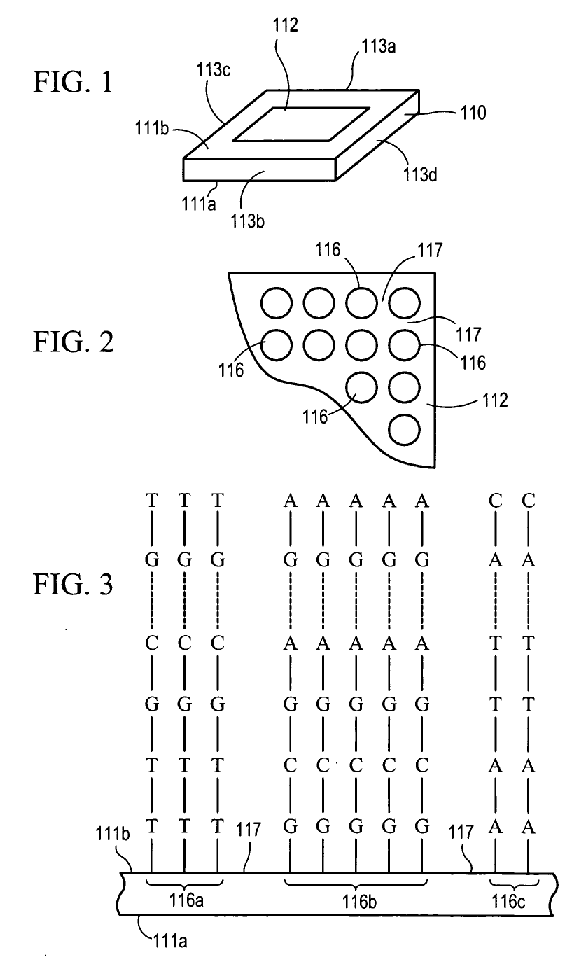

An exemplary array is shown in FIGS. 1-3, where the array shown in this representative embodiment includes a contiguous planar substrate 110 carrying an array 112 disposed on a rear surface 111b of substrate 110. It will be appreciated though, that more than one array (any of which are the same or different) may be present on rear surface 111b, with or without spacing between such arrays. That is, any given substrate may carry one, two, four or more arrays disposed on a front surface of the substrate and depending on the use of the array, any or all of the arrays may be the same or different from one another and each may contain multiple spots or features. The one or more arrays 112 usually cover only a portion of the rear surface 111b, with regions of the rear surface 111b adjacent the opposed sides 113c, 113d and leading end 113a and trailing end 113b of slide 110, not being covered by any array 112. A front surface 111a of the slide 110 does not carry any arrays 112. Each array 112 can be designed for testing against any type of sample, whether a trial sample, reference sample, a combination of them, or a known mixture of biopolymers such as polynucleotides. Substrate 110 may be of any shape, as mentioned above.

As mentioned above, array 112 contains multiple spots or features 116 of oligomers, e.g., in the form of polynucleotides, and specifically oligonucleotides. As mentioned above, all of the features 116 may be different, or some or all could be the same. The interfeature areas 117 could be of various sizes and configurations. Each feature carries a predetermined oligomer such as a predetermined polynucleotide (which includes the possibility of mixtures of polynucleotides). It will be understood that there may be a linker molecule (not shown) of any known types between the rear surface 111b and the first nucleotide.

Substrate 110 may carry on front surface 111a, an identification code, e.g., in the form of bar code (not shown) or the like printed on a substrate in the form of a paper label attached by adhesive or any convenient means. The identification code contains information relating to array 112, where such information may include, but is not limited to, an identification of array 112, i.e., layout information relating to the array(s), etc.

In the case of an array in the context of the present application, the “target” may be referenced as a moiety in a mobile phase (typically fluid), to be detected by “probes” which are bound to the substrate at the various regions.

A “scan region” refers to a contiguous (preferably, rectangular) area in which the array spots or features of interest, as defined above, are found or detected. Where fluorescent labels are employed, the scan region is that portion of the total area illuminated from which the resulting fluorescence is detected and recorded. Where other detection protocols are employed, the scan region is that portion of the total area queried from which resulting signal is detected and recorded. For the purposes of this invention and with respect to fluorescent detection embodiments, the scan region includes the entire area of the slide scanned in each pass of the lens, between the first feature of interest, and the last feature of interest, even if there exist intervening areas that lack features of interest.

An “array layout” refers to one or more characteristics of the features, such as feature positioning on the substrate, one or more feature dimensions, and an indication of a moiety at a given location. “Hybridizing” and “binding”, with respect to nucleic acids, are used interchangeably.

By “remote location,” it is meant a location other than the location at which the array is present and hybridization occurs. For example, a remote location could be another location (e.g., office, lab, etc.) in the same city, another location in a different city, another location in a different state, another location in a different country, etc. As such, when one item is indicated as being “remote” from another, what is meant is that the two items are at least in different rooms or different buildings, and may be at least one mile, ten miles, or at least one hundred miles apart. “Communicating” information references transmitting the data representing that information as electrical signals over a suitable communication channel (e.g., a private or public network). “Forwarding” an item refers to any means of getting that item from one location to the next, whether by physically transporting that item or otherwise (where that is possible) and includes, at least in the case of data, physically transporting a medium carrying the data or communicating the data. An array “package” may be the array plus only a substrate on which the array is deposited, although the package may include other features (such as a housing with a chamber). A “chamber” references an enclosed volume (although a chamber may be accessible through one or more ports). It will also be appreciated that throughout the present application, that words such as “top,” “upper,” and “lower” are used in a relative sense only.

The term “stringent assay conditions” as used herein refers to conditions that are compatible to produce binding pairs of nucleic acids, e.g., surface bound and solution phase nucleic acids, of sufficient complementarity to provide for the desired level of specificity in the assay while being less compatible to the formation of binding pairs between binding members of insufficient complementarity to provide for the desired specificity. Stringent assay conditions are the summation or combination (totality) of both hybridization and wash conditions.

A “stringent hybridization” and “stringent hybridization wash conditions” in the context of nucleic acid hybridization (e.g., as in array, Southern or Northern hybridizations) are sequence dependent, and are different under different experimental parameters. Stringent hybridization conditions that can be used to identify nucleic acids within the scope of the invention can include, e.g., hybridization in a buffer comprising 50% formamide, 5×SSC, and 1% SDS at 42° C., or hybridization in a buffer comprising 5×SSC and 1% SDS at 65° C., both with a wash of 0.2×SSC and 0.1% SDS at 65° C. Exemplary stringent hybridization conditions can also include a hybridization in a buffer of 40% formamide, 1 M NaCl, and 1% SDS at 37° C., and a wash in 1×SSC at 45° C. Alternatively, hybridization to filter-bound DNA in 0.5 M NaHPO₄, 7% sodium dodecyl sulfate (SDS), 1 mM EDTA at 65° C., and washing in 0.1×SSC/0.1% SDS at 68° C. can be employed. Yet additional stringent hybridization conditions include hybridization at 60° C. or higher and 3×SSC (450 mM sodium chloride/45 mM sodium citrate) or incubation at 42° C. in a solution containing 30% formamide, 1M NaCl, 0.5% sodium sarcosine, 50 mM MES, pH 6.5. Those of ordinary skill will readily recognize that alternative but comparable hybridization and wash conditions can be utilized to provide conditions of similar stringency.

In certain embodiments, the stringency of the wash conditions that set forth the conditions which determine whether a nucleic acid is specifically hybridized to a surface bound nucleic acid. Wash conditions used to identify nucleic acids may include, e.g.: a salt concentration of about 0.02 molar at pH 7 and a temperature of at least about 50° C. or about 55° C. to about 60° C.; or, a salt concentration of about 0.15 M NaCl at 72° C. for about 15 minutes; or, a salt concentration of about 0.2×SSC at a temperature of at least about 50° C. or about 55° C. to about 60° C. for about 15 to about 20 minutes; or, the hybridization complex is washed twice with a solution with a salt concentration of about 2×SSC containing 0.1% SDS at room temperature for 15 minutes and then washed twice by 0.1×SSC containing 0.1% SDS at 68° C. for 15 minutes; or, equivalent conditions. Stringent conditions for washing can also be, e.g., 0.2×SSC/0.1% SDS at 42° C.

A specific example of stringent assay conditions is rotating hybridization at 65° C. in a salt based hybridization buffer with a total monovalent cation concentration of 1.5 M (e.g., as described in U.S. patent application Ser. No. 09/655,482 filed on Sep. 5, 2000, the disclosure of which is herein incorporated by reference) followed by washes of 0.5×SSC and 0.1×SSC at room temperature.

Stringent assay conditions are hybridization conditions that are at least as stringent as the above representative conditions, where a given set of conditions are considered to be at least as stringent if substantially no additional binding complexes that lack sufficient complementarity to provide for the desired specificity are produced in the given set of conditions as compared to the above specific conditions, where by “substantially no more” is meant less than about 5-fold more, typically less than about 3-fold more. Other stringent hybridization conditions are known in the art and may also be employed, as appropriate.

Sensitivity is a term used to refer to the ability of a given assay to detect a given analyte in a sample, e.g., a nucleic acid species of interest. For example, an assay has high sensitivity if it can detect a small concentration of analyte molecules in sample. Conversely, a given assay has low sensitivity if it only detects a large concentration of analyte molecules (i.e., specific solution phase nucleic acids of interest) in sample. A given assay's sensitivity is dependent on a number of parameters, including specificity of the reagents employed (e.g., types of labels, types of binding molecules, etc.), assay conditions employed, detection protocols employed, and the like. In the context of array hybridization assays, such as those of the present invention, sensitivity of a given assay may be dependent upon one or more of: the nature of the surface immobilized nucleic acids, the nature of the hybridization and wash conditions, the nature of the labeling system, the nature of the detection system, etc.

### DESCRIPTION OF SPECIFIC EMBODIMENTS

To further interpret and understand the meaning of aberrations discovered using CGH measurement technologies investigators are interested in understanding the genomic content of aberrant regions. The present methods, systems and computer readable media provide for the elucidation and/or statistical assessment of auxiliary defined biological categories, members of which have enriched representation in either the aberrant regions or in the non-aberrant regions of chromosomes, as identified by CGH analysis. The high resolution enabled by oligonucleotide aCGH makes the determination of representation much more accurate, since the determination of residence of a genomic element in an altered region is more accurate. Oligonucleotide aCGH methods are sufficiently sensitive to detect a single copy number difference or change in the amount of a sequence between any two given samples. The resolution may be sufficiently high to determine the boundaries of measured genome alterations, up to a theoretical limit of single 60 mer probes, as noted. The methods and systems provided herein may leverage this accuracy/resolution in assessing enrichment as part of the interpretation and data analysis process. Furthermore methods and systems described herein may serve as tools for interpreting other types of data, in conjunction with CGH data.

Solutions are provided for incorporating auxiliary information in interpreting the results of measuring DNA copy number changes. Interpretations of CGH data may be furthered by searching for enriched elements defined by an auxiliary source of information (e.g., functional annotation such as GO (Gene Ontology), sequence elements, genes with measured differential expression, etc). For example, investigation may be carried out as to how differential expression (e.g., measuring expression levels of a tumor tissue sample versus a “normal” (non-tumor) sample of the same type of tissue) is localized, or not, to aberrant regions. In addition, the present methods may be used to help interpretation of data coming from other experimental approaches.

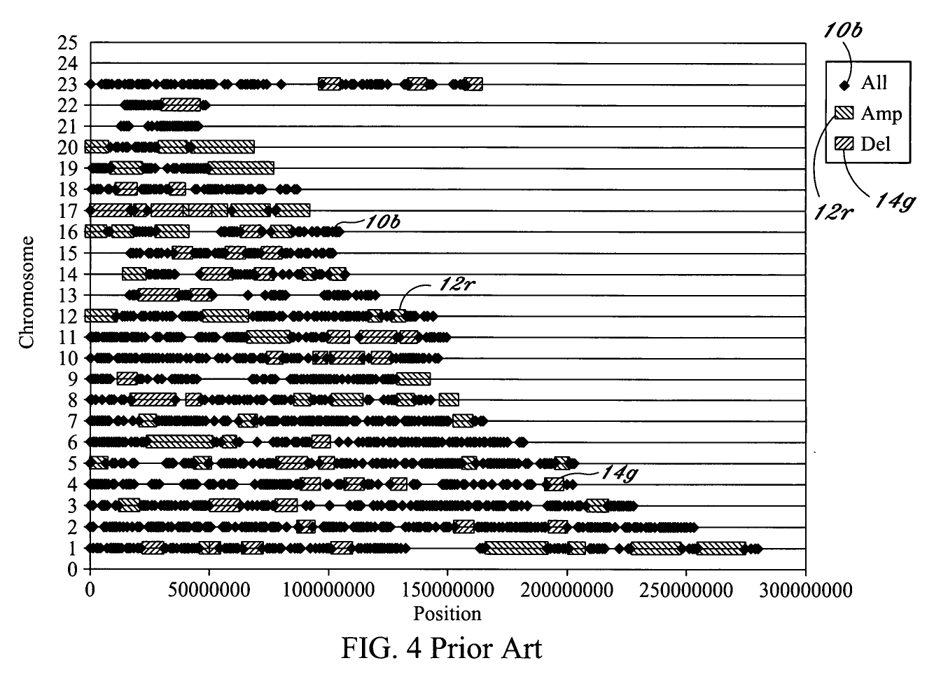

Data outputted by CGH methods may provide expression data, the analysis of which may identify regions along one or more chromosomes, in which genetic material in such regions has been amplified or deleted, see for example, Hupe et al., “Analysis of array CGH data: from signal ratio to gain and loss of DNA regions” Bioinformatics, vol. 20, no. 18, 2004, pp 3413-3422 and Sebat et al., “Large-Scale Copy Number Polymorphism in the Human Genome”, Science, vol. 305, 23 Jul. 2004, pp. 525-528, both of which are incorporated herein, in their entireties, by reference thereto. Such regions are referred to here as “aberrant regions”. FIG. 4, discussed above, shows an example of analysis of aCGH data to call out aberrant regions, that are visually displayed with regard to the chromosomes on which they occur, along with regions that have not been amplified or deleted (“non-aberrant regions”) and in locations which are geographically accurate as to where such aberrant regions actually occur on the chromosomes, as indicated by the “Position” axis or X-axis.

The accuracy and resolution of current aCGH techniques enables the identification of the individual genes that are resident in each aberrant region (as well as genes that are resident in the non-aberrant regions). Therefore, for one or more aberrant regions, a set of genes can be identified for further characterization of the tissues being analyzed. For example, if some type of characterization or annotation of a “universe” of genes is known, where the universe or universal set includes not only the set located in the aberrant region or regions, but also all other genes being considered (e.g., on an array, for a genome, or other universal set), then the characterization/annotation of the universal set, when considered with the set of genes from the aberrant region(s), may be used to identify some common property(ies) or function(s) of genes that have been deleted and/or amplified. Such analysis may facilitate a determination as to whether there is a common process or function occurring that is relevant to the disease or other genetic malady that is occurring.

Descriptions, characterizations and/or annotations of genes may be references from such sources as the gene ontology project (http://www.geneontology.org/), published sets of cancer-related genes that cancer biologist are generally interested in, a list of differentially expressed genes between normal cells and diseased cells, such as from a cancer study or other disease study, or other compilation of genes with annotations/descriptions, where the information derived is from one or more studies that are completely separate from the CGH data with which it will be compared, but which one or more studies are also with regard to the same disease or condition that is being studied as reported by the CGH data. An analysis may then be conducted to determine whether the one or more aberrant regions contain significantly more cancer-related genes, or some other genes that are related to a process or function that the researcher is interested in and which are annotated by the set of universal genes, then the number of such genes that would be expected if occurring at random.

As one non-limiting example, the concepts describing which are generally applicable to other universes U, specific categories or sets Γ, and regions of interest A, if the universe U includes all of the genes represented on a microarray, the interval of interest A represents the aberrant regions, including both regions of deletion and amplification, on a chromosome, and the specific category or set Γ is a set of genes that were differentially expressed in a different study, but a study of the same disease currently being studied, then an analysis is carried out to determine how many of the genes in Γ lie within A and to determine how greatly or significantly the number of genes in Γ that lie within A differs from the number of genes in Γ that would be expected to occur at random within an interval the size of A.

For binary data, such as defined in the previous example, a relationship between the fraction of elements of Γ (genes g) that resides in A, and the fraction of elements of U (genes g) that resides in A, determined according to the following:

$$R ( Γ , A ) = \frac{\vert \{ g \text{:} g ∈ Γ and g ∈ A \} \vert}{\vert Γ \vert} \qquad ( 1 )$$

where R(Γ, A) is the fraction of Γ that resides in A (i.e., the number of genes resulting from the intersection of genes that reside in Γ with the genes that reside in A, divided by the total number of genes in Γ), and

$$R ( U , A ) = \frac{\vert \{ g \text{:} g ∈ U and g ∈ A \} \vert}{\vert U \vert} \qquad ( 2 )$$

where R(U,A) is the fraction of U that resides in A (i.e., the number of genes resulting from the intersection of genes that reside in U with the genes that reside in A, divided by the total number of genes in U). If the occurrence of genes from the specific set Γ is completely random throughout, then R(Γ,A) is expected not to deviate much from R(U,A). An over-representation, or enrichment of the aberrant region(s) A with genes from the specific set F will be reflected by R(Γ,A)>R(U,A). A significant difference between the value of R(Γ,A) and R(U,A) implies some relationship or link between the specific set and the disease or condition currently being studied, from which aberrant regions A were identified.

To assess the enrichment of members of Γ within A, a p-value of the number of such elements may be computed under a Binomial null model [Binom(|Γ|,R(U,A))]. By letting n=|Γ| and p=R(U,A) then the probability of finding k or more such elements is:

$${\sum }_{i = k}^{n} ( \begin{matrix}n \\ i\end{matrix} ) {{p}^{i} ( 1 - p )}^{n - i} \qquad ( 3 )$$

where, k=R(Γ,A)|Γ|.

If Γ⊂U, e.g. when Γ is a subset of the complete set of genes with known locations U, the p-value of the number of A resident elements, k=R(Γ,A)|Γ|, may alternatively be computed under a hypergeometric model. Namely, if N=|U| and S=R(U,A)|U| the probability of finding k or more such elements is:

$$Hygetail ( k , N , S , n ) = {\sum }_{i = k}^{ n} \frac{( \begin{matrix}n \\ i\end{matrix} ) ( \begin{matrix}N - n \\ S - i\end{matrix} )}{( \begin{matrix}N \\ S\end{matrix} )} \qquad ( 4 )$$

Another approach to assessing enrichment of members is to calculate statistical significance using false discovery rate (FDR) assessment, as described in Benjamini, Y., Hochberg, Y. (1995). “Controlling the False Discovery Rate: a Practical and Powerful Approach to Multiple Testing”, Journal of the Royal Statistical Society B, 57 289-300, which is incorporated herein, in its entirety, by reference thereto.

If a specific set of genes Γ has not been defined or is not available to use for binary data analysis as described above, but there is available a set of genes or other sequence elements U to which quantitative annotation is assigned, such that the members of U may be ordered, e.g., f:U→R, (i.e., a real-valued function is defined for U, the set of all genes (or other sequence elements) being considered). Examples of quantitative data include, but are not limited to: genes with scores for differential expression, sequence locations with affinity signals from ChIP chip assays, Single Nucleotide Polymorphism (SNP) loci with linkage or association signals in a genetic study, etc. Aberrant regions or intervals (i.e., members of A are then sought that harbor an unusual sample distribution (e.g., statistically significant difference from random) taken from the values of the signal for the entire population of entities studied. To achieve this, a statistical assessment of the difference between the distribution of {f(u):uεU} and {f(u):uεA}. That is, an analysis is performed to attempt to find a threshold t, based upon which a set Γ={u:f(u)>t} can be defined for use in analysis based upon the binary data model described in detail above.

As a specific example, consider a study of differential expression where data has been taken to show genes that are differentially expressed when measured in breast tumor tissue samples versus normal breast tissue samples. A set of 10,000 genes is ranked according to the degree of differential expression based on the quantitative differential expression values associated with each gene, with the most highly differentially expressed gene being ranked as number 1 and the least differentially expressed gene, ranked as 10,000. From this ranked set, an analysis can then be carried out on one or more subsets of the ranked genes to observe where the subset of genes is located with regard to aberrant regions A in a current study for which CGH data has been provided. For example, a first analysis may be conducted with the top ten percent of genes, or ranks 1 through 1,000. It is then determined where each of the genes 1 through 1,000 reside on the chromosomes of the CGH study and how many reside in aberrant regions versus non-aberrant regions. If a significant amount more of these genes reside in aberrant regions than would be expected for a random distribution of these genes, then the set is determined to have some relationship to the phenomenon being studied that is the subject of the CGH data.

More generally, an analysis may be made to identify where the distribution of differentially expressed gene rankings inside the aberrant region or regions is different (significantly) from the overall distribution of differentially expressed gene rankings (across the entire genome). One distribution is based on all function values of genes that are inside the aberrant interval {f(u):uεA}, and the other distribution is described by {f(u):uεU}. Various methods can be applied to compare these distributions.

Methods for comparing the above distributions include those described immediately hereafter, but are not limited thereto. One such method includes randomly assigning values of the function f to the elements that reside in A by drawing from the set {f(u):uεU} and computing a statistic (e.g., sum of values) on this set of numbers; repeating the randomly assigning and computing a large number of times (e.g. 10,000, but this number may be larger or smaller depending upon the total number of members in the set, as well as other factors), and then comparing the value of the statistic actually attained in A. Another method involves use of a Student t-test. Another alternative is to use Wilcoxon statistics, see Wilcoxon, “Individual Comparisons by Ranking Methods”, Biometrics 1, 80-83, 1945, which is incorporated herein, in its entirety, by reference thereto. Another option is to use a threshold on the quantitative data and then apply the above methods for binary data. That is, binary data is created from quantitative data by defining Γ as the set of all u, such that f(u)>t, or, alternatively, f(u)<t, for the resulting categorical data. The value of the threshold can be varied to obtain a function form of the statistics.

Note that a specific set Γmay be a specific set of genes, as noted, or other types of sequence elements (sequence motifs, miRNA (micro RNA) precursors, structure motifs, regulatory elements, Transcription Factor Binding Sites (TFBS's), sequences determined by homology to another organism, etc. The present methodologies have many different applications as means to provide further information and insight based upon CGH data and another set of annotated data. For example, a specific set Γ may be identified as all genes known to be associated with breast cancer, aberrant regions A may be a set of regions determined in a breast cancer CGH study to be commonly aberrant, and the set U may be all genes with known locations on the human genome. As another example, a specific set Γ may be identified as all members of a Gene Ontology (GO) term (as defined in the Gene Ontology project), aberrant regions A may be a set of regions determined in a breast cancer CGH study to be commonly aberrant, and the set U may be all genes with known locations on the human genome.

Another example may define a specific set Γ as all genes known to annotated in GO to be DNA repair genes, aberrant regions A may be a set of regions determined in a breast cancer CGH study to be commonly aberrant, and the set U may be all genes with known locations on the human genome. Still further, a specific set Γ may be identified as all members of a GO term (as defined in the Gene Ontology project), aberrant regions A may be a set of regions determined in a breast cancer CGH study to be commonly deleted, and the set U may be all genes with known locations on the human genome.

A further example may define a specific set Γ as all known oncogenes associated with breast cancer, as retrieved from a curated database, aberrant regions A may be a set of regions determined in a lung cancer CGH study to be commonly amplified, and the set U may be all genes with known locations on the human genome. A still further example defines a specific set Γ as all genes differentially expressed in breast cancer, as determined by an independent or by a related expression profiling study, aberrant regions A may be a set of regions determined in a breast cancer CGH study to be commonly aberrant, and the set U may be all genes with known locations on the human genome. As an alternative to the previous example, the specific set Γ is the same, i.e., defined as all genes differentially expressed in breast cancer, as determined by an independent or by a related expression profiling study, aberrant regions A are the same, i.e., a set of regions determined in a breast cancer CGH study to be commonly aberrant, and the set U may be all genes covered by the array design used in the microarray used to carry out the expression profiling study mentioned.

As another example, set Γ may be defined as all genes over-expressed in breast cancer tumor cells versus normal cells (as determined by an independent or by a related expression profiling study); set A may be defined as a set of regions determined in a breast cancer CGH study to be commonly amplified, and set U may be defined as all genes covered by the array design of the microarray used for obtaining the expression levels in the expression profiling study from which Γ was defined.

In another example, the set Γ may be defined as all locations determined to bind to a transcription factor (TF) in a ChIP chip assay, under a certain condition, the set A may be defined as a set of regions determined in a breast cancer CGH study to be commonly amplified and their close genomic vicinity which may include up to about 2 Mb, up to about 1 Mb, up to about 0.5 Mb, or up to about 0.1 Mb, on each side, and the set U may be defined as all promoter regions with known genomic location. An alternative example similarly defines Γ as all locations determined to bind to a TF in a ChIP chip assay, under a certain condition and A as a set of regions determined in a breast cancer CGH study to be commonly amplified and their close genomic vicinity, but defines the set U as all location elements measured in the ChIP chip assay.

Another example defines the set Γ as all occurrences of a sequence motif, μ, defines the set A as a set of regions determined in a breast cancer CGH study to be commonly amplified and their close genomic vicinity, as defined above, and set U is defined as all occurrences of a representative set of motifs of length equal to that of μ. This leads to R(U,A)=the genomic fraction of amplified regions. In another example, Γ may be defined as the set of all occurrences of a sequence motif, μ, which corresponds to the binding site of a certain miRNA molecule, the set A may be defined as a set of regions determined in a breast cancer CGH study to be commonly amplified and their close genomic vicinity, and U may be defined as the set of all occurrences of a representative set of motifs of length equal to that of μ. This leads to R(U,A)=the genomic fraction of amplified regions

As a quantitative data example, U and f may be defined by quantitative data representing linkage signals of SNP sites to a certain phenotype (such as response to treatment, for example), and the set A may be defined as a set of regions determined in a lung cancer CGH study to be commonly deleted. In another quantitative data example, U and f are defined by quantitative data representing cancer versus normal differential expression signals for genes (as determined by an independent or by a related expression profiling study), and A is defined as a set of regions determined in a CGH study to be commonly deleted.

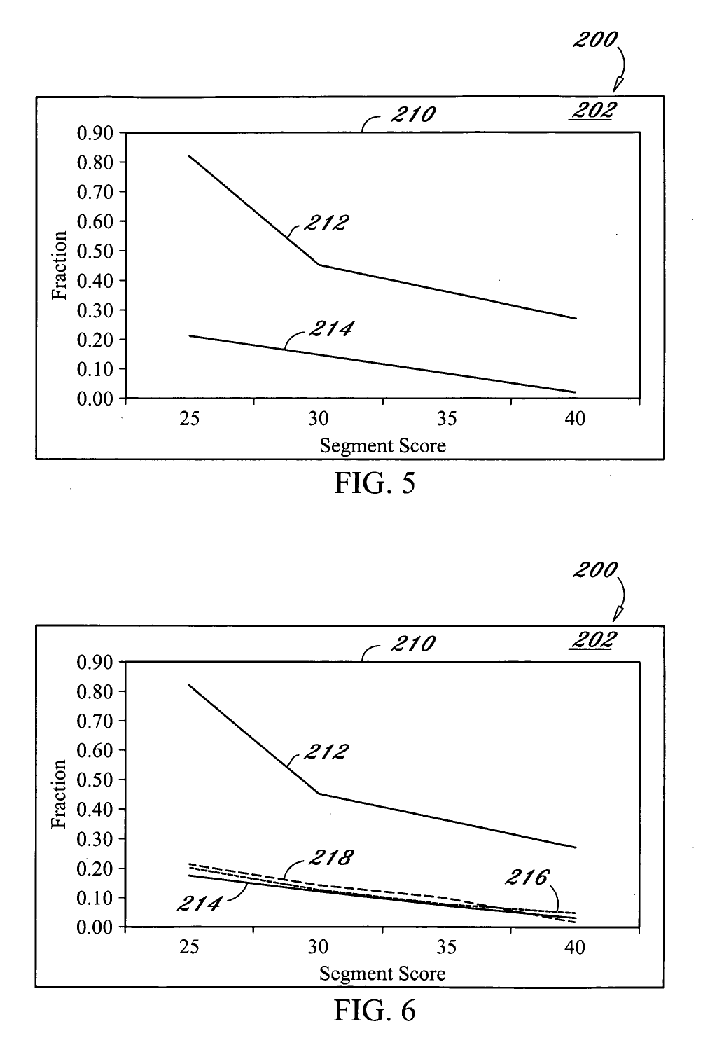

In addition to the software, hardware and/or firmware that may be employed to perform the methods as described above, the present systems may further include reporting tools to facilitate a user's access to results of such methods. FIG. 5 is a schematic representation of a user interface 200 implementing a tool 202 configured to graphically output calculated enrichment results. For example, through user interface 200, tool 202 may display a graphical output of results characterizing enrichment of aberrant regions A in a breast cancer study. In this example, the set Γ was derived from a curated web-site that lists genes that are related to several pathologies, see http://www.sanger.ac.uk/genetics/CGP/Census/. The set Γ was defined as all genes reported in the aforementioned site as associated with breast cancer, the set A was defined as a set of regions determined on the basis of the breast cancer data of Pollack et al. in “Microarray analysis reveals a major direct role of DNA copy number alteration in the transcriptional program of human breast tumors”, PNAS, 99(2):12963-8, and U was defined to be the set of all RefSeq human genes, e.g., see http://www.ncbi.nlm.nih.gov/RefSeq/.

Enrichment analysis was performed by the system according to the methods described above. Results of the enrichment analysis were displayed on graphical display 210 as schematically shown in FIG. 5. The X-axis of graphical output 210 represents the stringency by which intervals are determined to be amplified or deleted in the breast cancer data set for which CGH data was provided (i.e., the data from Pollack et al.). Aberrant intervals or regions were determined as commonly aberrant using the methods described in Lipson et al., “Joint Analysis of DNA Copy Numbers and Gene Expression Levels”, WABI 2004, LNCS 3240, 135-146, Springer-Verlag, 2004, which is incorporated herein, in its entirety by reference thereto. The values for the X-axis are statistical scores, such that, for example, the data above 25 is for amplification with a p-value of 10⁻²⁵. Additional discussion of p-values and their calculation can be found in Lipson et al., “Joint Analysis of DNA Copy Numbers and Gene Expression Levels”, which was incorporated by reference above. That is, an interval/region is declared to be amplified (aberrant)if the confidence level for such declaration, given the data, is 10⁻²⁵. Therefore, the larger the number on the X-axis (i.e., as we move further to the right along the X-axis), the more stringent is the decision for determining what regions are amplified.

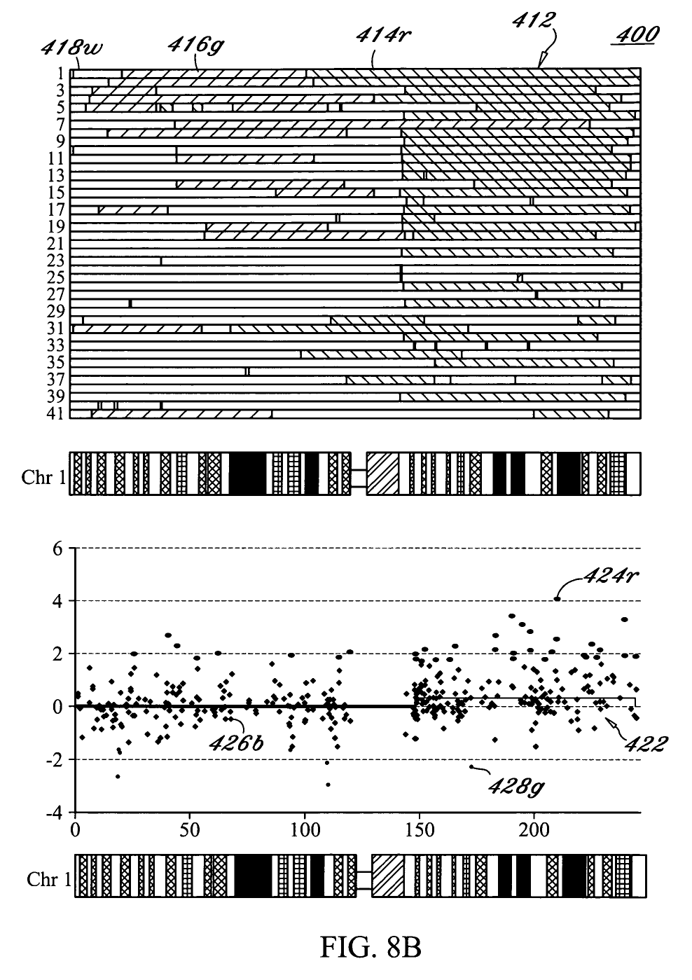

In this example, using a stringency of 25, then about 80% (i.e., R(Γ,A)=0.80) of the breast cancer genes in Γ are also located in A, i.e., are in the amplified regions of the CGH breast cancer data, as indicated by the plot 212 of the fraction of Γ in A. This is a highly surprising event, which can be considered to convincingly show a link between the genes reported to be associated with breast cancer and the breast cancer data of Pollack et al. Calculation of a p-value for this occurrence confirms that this is a highly surprising event. A further detailed description of an example of calculation of a p-value is contained below, following the detailed descriptions for FIGS. 8B and 8C. Comparatively, only about 18% of U (all RefSeq human genes) are also located in A (i.e., R(U,A)=0.18), for a given stringency of 25. Therefore, when comparing R(Γ,A) with R(U,A) it is clear that the aberrant regions of the CGH data are enriched with the known genes associated with breast cancer.

It will be readily apparent to those of ordinary skill in the art, that additional or alternative means for outputting results may be employed by the system including, but not limited to printers, for printing output results on paper or other hard copy media, electronic outputs, that may be stored in storage means and or emailed for conversion to a viewable output medium, such as those discussed above, as well as other output means known in the art.

As further validation of the methods described herein, FIG. 6 shows graphical display 210 in which, in addition to plots 212 and 214 described above, additional plots 216 and 218 have been outputted, as a result of additional enrichment computations performed with regard to two additional Γ classes or sets. This was an example where the breast cancer genes were enriched, but the other categories did not yield very high enrichment scores. The same sets for A and U that were used in performing the calculations upon which the results in FIG. 5 are based were used to perform the calculations for each of the plots 212, 214, 216 and 218 with regard to FIG. 6.

The plot 216 is further based upon calculations performed with regard to the Γ set which was derived from the curated web-site that lists genes that are related to several pathologies, see http://www.sanger.ac.uk/genetics/CGP/Census/ and which was defined as all genes reported there as associated with cancer in general. The plot 218 is further based upon calculations performed with regard to the Γ set which was derived from the Gene Ontology Website, http://www.geneontology.org/, and which was defined as the set of all genes annotated as DNA repair genes in GO. By comparing the values of each of there two plots 216 and 218 with the value of the set U (plot 214) at a stringency of 25, it can be observed that that values do not greatly differ from one another. Thus, for each of these instances of comparison of R(Γ,A) with, the values are not far from equal, and distributions of these types of genes are not surprising, but are considered to be close to random.

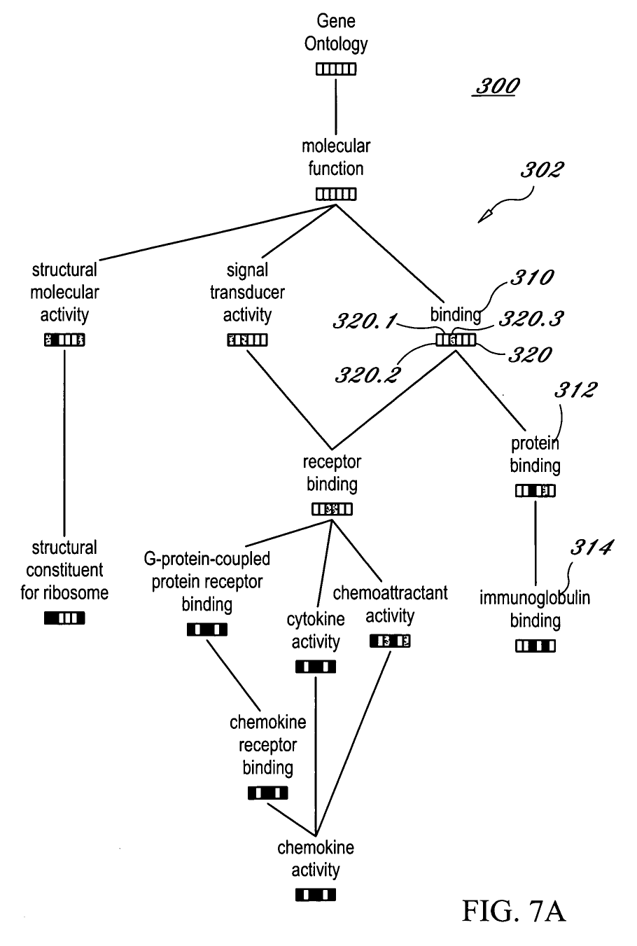

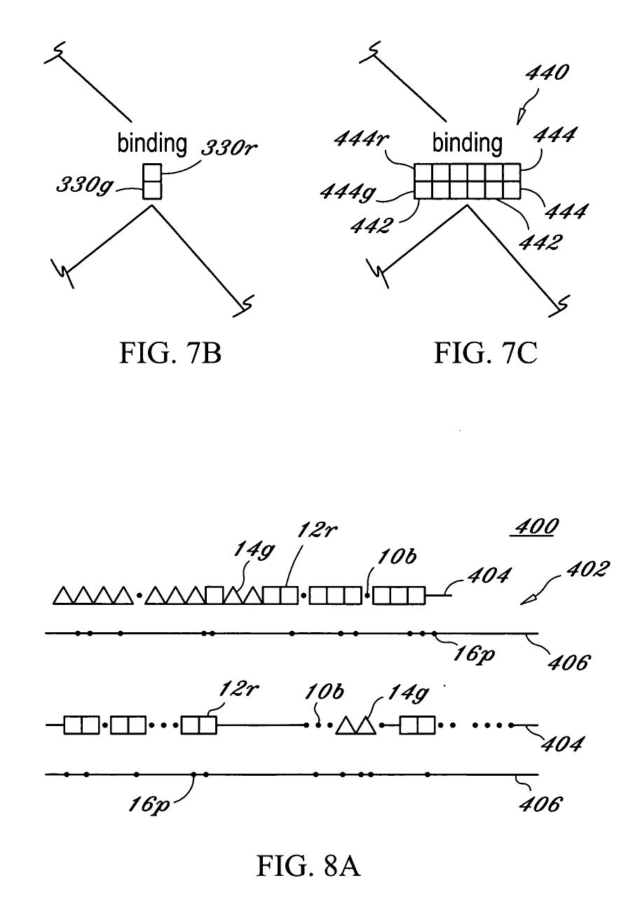

When the set Γ is derived from GO terms the calculated results can be visually represented using a tool 300 with respect to a GO tree visualization The Gene Ontology project includes different general biological terms with sets of genes that are associated with each term. The terms are organized in a hierarchical way such that more general terms branch off to more specific terms. Thus, for example, in FIG. 7, the term “binding” 310 (sometimes as referred to as a “parent” in the relationship described) is broader than the term “protein binding” 312 (which, in this example, may be referred to as a “child” of 310) which is in turn broader than the term “immunoglobulin binding” 314 (a “child” of 312 and also a “child” of 310 but may be more specifically referred to as a “grandchild” of 310). For each term in the GO tree (currently, at the time of this writing, there are around four thousand GO terms) an enrichment analysis is performed on the basis where the set Γ is defined by the genes listed in the current GO term being considered. The set A is characterized by the aberrant region/regions in the sample that is currently being considered, and the set U may be the entirety of the genes on an array that generated the sample or some other universal set as described previously. For example, U may be the set of all annotated genes on the array (e.g., all genes that are assigned to one of the GO categories) and U may also be the set of all genes on the array. Thus, the total number of genes is counted that belong to the set Γ that is defined by the genes listed in the current GO term or any of its children(i.e., that branch off from that term) being considered, the number of those genes that fall within an aberrant region A is also counted, and the number of genes in U is counted, for performance of the enrichment analysis with respect to the current interval/region and GO term being considered. Analysis may be done for each aberrant interval/region in each sample, or it may be done for common aberrant intervals/regions and then the analysis is not applied to each sample, but is done commonly across all samples for the same aberrant region or regions. Further alternatively, or additionally, each sample may be analyzed separately with regard to a common interval. If analysis is done for each sample, then aberrant regions may be different for each sample. The number of genes that fall in each interval, as determined by each sample are counted during the analysis. Hence if intervals are different, the number of genes that fall into them may also be different.

When these calculations are repeated for each sample in the study, and the significance of enrichment of the genes associated in each of the terms with respect to aberrant regions in the sample is reported adjacent each term in the tree 302. For example, a graphical representation 320, somewhat like a heat map, may be used to report with regard to each sample considered. In FIG. 7, graphical strips 320 are overlaid on the GO tree structure adjacent the terms that were used in the calculations being reported. Each annotation associated with a GO term may be represented as a vector, with each member of the vector indicating a degree of amplification or deletion, or neutrality, for a sample, with respect to what is represented by the adjacent GO term.

Thus, in the example of FIG. 7, enrichment calculations were carried out with sets of genes for each term for each of six samples to determine whether those particular genes are over-represented in the aberrant regions of the sample being considered. Each box or cell of the graphical representation/vector 320 may represent one of the samples analyzed, and these cells are displayed in the same order under each term, so that a specific sample result can be readily accessed. The color and/or intensity of the cells are proportional to the degree of enrichment or level of significance (e.g., proportional to the p-value) that the particular term bears to the sample being reported on. For example, no or very little significance may be indicated by a white cell as in cell 320.1 and the highest levels of significance may be indicated by the highest intensity of red color, with intermediate values ranging in hues and/or intensity between the white and red extremes. In the example shown, the significance of the enrichment of sample 3 with the genes associated with the term binding 310 is greater than the significance of the enrichment of sample 2 with the same genes, as is readily visually apparent by comparing the brighter red color of cell 320.3 with the fainter color of cell 320.2. Of course, other color schemes may be substituted to differentiate different p-values/levels of significance with regard to the samples that are analyzed.

Note that the enrichment analysis is valid for common aberrations, for deletions and amplifications separately, as well as at the level of single samples. In addition, several sample types can be considered, e.g. clustered. For every Γ under consideration, more than one numerical value may thus need to be represented, which may be graphically represented, as already described with regard to 320, and/or numerically represented.

Alternatively, samples can be considered together to determine common regions of amplification and/or deletion. In this case, annotation of each GO term may be made to display only two indicators or cells, one to indicated a degree of common amplification of the genes, over all samples considered, with respect to what is represented by the adjacent GO term, and the other of the indicators/cells to indicate a degree of common deletion of the genes, over all samples considered, with respect to what is represented by the adjacent GO term. FIG. 7B is a partial view of a GO tree showing only the “binding” term for simplifying the example. In this case, cell 330r is provided to represent a degree of common amplification of the genes, over all samples considered, with respect to “binding”, while cell 330g is provided to represent a degree of common deletion of the genes, over all samples considered, with respect to “binding”. Cell 330r may take on varying shades/intensities of red to visually represent a degree of amplification, respectively, and when white, indicates no appreciable amplification. Similarly, cell 330g may take on varying shades/intensities of green to visually represent a degree of deletion, respectively, and when white, indicates no appreciable deletion.

Further alternatively, each annotation may be represented by a matrix, wherein each column or row of the matrix has two cells, one cell indicating whether or not amplification was found for a sample, with respect to what is represented by the adjacent GO term, and the other cell indicating whether or not deletion was found for the sample, with respect to what is represented by the adjacent GO term. Each row or column, respectively, represents a sample that was analyzed. Further alternatives to annotations provided adjacent GO terms may be provided, as would be apparent to those of ordinary skill in the art after reading the present disclosure.

FIG. 7C is a partial view of a GO tree showing only the “binding” term for simplifying the example. In this example, each row 444 represents one of amplification and deletion, and contains cells 444r or 444g. Each column 442 represents a sample that is represented by cells 444r and 444g in that column. Each column 442 of matrix 440 has two cells, one cell 444r indicating whether or not amplification was found for a sample, with respect to what is represented by the adjacent GO term “binding”, and the other cell 444g indicating whether or not deletion was found for the sample, with respect to what is represented by the adjacent GO term binding. Cells 444r may be color-coded red (or white when there is no amplification reported) according to the scheme described above with respect to FIG. 7B, for example. Similarly, cells 444g may be color-coded green (or white when there is no deletion reported) according to the scheme described above with respect to FIG. 7B, for example.

Further alternatives to annotations provided adjacent GO terms may be provided, as would be apparent to those of ordinary skill in the art after reading the present disclosure.

Another visual output that the present system is configured to produce is represented in FIG. 8A. Like other outputs discussed, this output may be electronically produced on a display by the user interface and/or outputted on paper or other physical, hard copy media. Additionally, the output may be stored in electronic form on one or more storage media and/or transmitted electronically over a private network and/or public network.

Tool 400 is provided for visual representation of enrichment data. FIG. 8A is a schematic representation of an output 402 by tool 400. For simplicity, only chromosomes 16 and 17 have been shown in FIG. 8A, but of course, tool 400 may output any number of chromosomes that are the subject of a CGH study. For example, chromosomes 1-23 may be represented similarly to that shown in FIG. 4, with the additional display of enrichment data as described hereafter. An entire genome may be represented along a line, or, for better resolution and detail, individual chromosomes may be graphically represented along lines 404. Typically, indicators will be provided to distinguish aberrant regions from non-aberrant regions, and more specifically visual representations will be made to distinguish locations of significant amplification, locations of significant deletion, and non-aberrant regions. Regions that have no genes present are apparent by a naked line that is a continuation of line 404. The various aberrant and non-aberrant regions may be distinguished by shape, size and/or color. A typical example is color-coded, e.g., 10b may be color-coded blue, 12r may be color coded red and 14g may be color-coded green, and the non-aberrant regions 10b are smaller and of a different shape than the aberrant regions. For purposes of this patent, the symbols have been modified to distinguish the regions of significant amplification 12r from the regions of significant deletion 14g without resorting to color distinction, for purposes of black-and-white drawings.

Tracks 406 may be displayed adjacent genome lines 404, as shown. An additional graphical representation of quantitative and/or binary data may be displayed on tracks 406 to provide further understanding and knowledge of where the genes (or other sequence elements) occur on the chromosomes. Thus, by viewing output 402 a user can easily and quickly see the locations of a set of sequence elements of interest, relative to aberrant regions that occur on the chromosomal/genome representation. The graphical representation of the quantitative data on tracks 406 may be distinguished from the graphical representations on lines 404, not only by location on a different line, by also by shape, size and/or color. In the example shown , dots 16p, if presented in color, would be purple to also distinguish from 10b, 12r and 14g by color. Further, quantitative data from more than one set of genes or other sequence elements may be represented on tracks 406. In such an instance, the graphical representation of the quantitative data on tracks 406 for each set may be distinguished from one another by shape, size and/or color.

Accordingly, tool 400 provides output in graphical form where the graphical representation of categorical data is provided along with a graphical representation of CGH data having been analyzed to call out aberrant regions. Graphical representation of quantitative and/or binary data may parallel the representation of CGH data along chromosomes, as described above. Alternatively, graphical representation of quantitative and/or binary data may be overlaid on the graphical representation of the CGH data. However, this could tend to clutter the visualization and therefore the graphical representation of quantitative and/or binary data is typically visualized in parallel with the graphical representation of the CGH data.

Note that output 402 can also be used to quantify the amount of enrichment of the aberrant (or non-aberrant) regions with regard to the set that is plotted on tracks 406. By counting the number of occurrences 16p that align with regions of interest (whether amplified regions, deleted regions, amplified and deleted regions, or non-aberrant regions) and comparing the total with the number of occurrences in the remaining regions, fractions of occurrences can be calculated by dividing each of these numbers by the total number of occurrences in the set overall. However, visualization 402 initially provides an overall view where it may be immediately apparent to the viewer that a particular set is over-represented in aberrant regions, whereby further details regarding quantification of such over-representation can then be pursued.

FIG. 8B shows a visualization 412,422 produced by tool 400 which, in this case, was electronically produced on a display. As noted above, outputs such as visualization 412 and all other outputs described herein, may be electronically produced on a display by the user interface and/or outputted on paper or other physical, hard copy media. Additionally, the output may be stored in electronic form on one or more storage media and/or transmitted electronically over a private network and/or public network.

FIG. 8B shows an aberration summary plot 412 of CGH data on chromosome 1, that was generated based on data presented by Pollack et al., “Microarray analysis reveals a major direct role of DNA copy number alteration in the transcriptional program of human breast tumors”, which was incorporated by reference above. Each numbered line 2-41 represents a sample that was analyzed according to techniques described herein, wherein red bars 414r represent amplifications and green bars represent deletions, with white bars 418w indicating neutrality, i.e., neither significantly amplified, nor significantly deleted. Degrees of amplification and deletion are indicated by shading/intensity of the colored bars. Thus, for example, a bright red bar 414r indicates a relatively greater degree of amplification than a light red or pink bar 414r, and a light green bar 416g indicates relatively less significant deletion than a bright green bar 416g.

A trend may be readily visualized, when viewing output 412 of FIG. 8B, since many of the samples share a common amplification from about 148 Mb to about 260 Mb, as indicated by the common alignment of red bars 414r. This is a good example of how a visual output can immediately alert a researcher to a potential relationship between particular genes and a condition that can lead to a further understanding of such condition.

Output 422 generated by tool 400 is shown underlying output 412 in FIG. 8B. Output 422 is a plot of significance of differential expression genes on chromosome 1 for breast cancer gene expression data, as further referenced in Van de Vijver et al., “A Gene-Expression Signature As A Predictor Of Survival In Breast Cancer”, N Engl J Med, Vol. 347, No. 25, Dec. 19, 2002, pp. 1999-2009, which is hereby incorporated herein, in its entirety, by reference thereto. Differential expression values are measured by comparing expression levels between samples from patients who developed metastasis within five years from the time that the sample (i.e., biopsy) was taken (short survival group) and samples from patients who did not develop metastasis within five years from the time the sample was taken (long survival group). In this example, red data points 424r represent genes that are significantly differentially expressed and that are more highly expressed in patients who developed metastasis within five years (short survival), than in samples from patients that did not develop metastasis within five years. Blue data points 426b represent genes that exhibit no significant difference between expression levels in the short survival group and expression levels in the long survival group. The green data points 428g represent genes that are significantly expressed and with higher expression in samples from patients who did not develop metastasis within five years, compared to the short survival group.

The y-axis shows differential expression values that are representative of expression ratios of long survival values to short survival values. In this example, a Student t-test value was computed for the long survival values relative to the short survival values. However, it is emphasized that values may be calculated using any number of other statistical tools, which would be readily apparent to one of ordinary skill in the art. Examples of some alternatives were listed above. The p-values obtained by the Student t-test were then further processed to determine−log (p-value) for each p-value. When the average expression value for the long survival values was greater than the average expression value for the short survival values, then the value for the calculated−log (p-value) (which is always positive) was made a negative value to show genes that are expressed and with higher expression in long survival samples than in short survival samples. When the average expression value for the short survival values was greater than the average expression value for the long survival values, the calculated−log (p-value) was left as a positive value. The x-axis indicates the position along chromosome 1 (for both the plotted data points 424r, 426b, 428g and the chromosome plot).

A researcher viewing output 422 would readily observe a high concentration of red points 424r starting around position 150 and extending to the end of the plot (at about 260), and this corresponds to the same range for which a relationship was observed in the output 412. Using the techniques described in Lipson et al., “Joint Analysis of DNA Copy Numbers and Gene Expression Levels”, more accurate starting and ending locations were identified as position 148553361 and position 228391647, respectively.

A p-value calculation was performed for an aberrant region defined by amplified interval A on chromosome 1, starting at position 148553361 and ending at position 228391647. The expression data studied has 5,760 genes (thereby defining U), and of the 5,760 genes, 162 genes belong to the interval defining A. There were 475 genes that showed significant differential expression between the short survival group and the long survival group. Using a t-test, p-value of 0.05, 29 of the 475 genes fell in the specified aberrant interval A on chromosome 1. For the random case, it is expected to see only 13.3594 (i.e., 475*162/5760) in the aberrant interval A. From this, the p-value was calculated according to the following, using equation (4):
P=1−Hygecdf(29−1, 5760, 475, 162)=4.5892e−005

This is the probability of observing 29 or more differentially expressed genes in a random case, based on hypergeometric distribution.

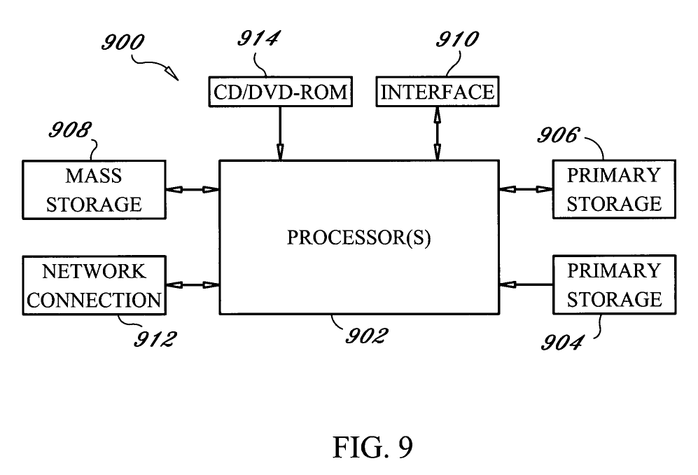

FIG. 9 illustrates a typical computer system that may be used to practice an embodiment of the present invention. The computer system 900 includes any number of processors 902 (also referred to as central processing units, or CPUs) that are coupled to storage devices including primary storage 906 (typically a random access memory, or RAM), primary storage 904 (typically a read only memory, or ROM). As is well known in the art, primary storage 904 acts to transfer data and instructions uni-directionally to the CPU and primary storage 906 is used typically to transfer data and instructions in a bi-directional manner Both of these primary storage devices may include any suitable computer-readable media such as those described above. A mass storage device 908 is also coupled bi-directionally to CPU 902 and provides additional data storage capacity and may include any of the computer-readable media described above. Mass storage device 908 may be used to store programs, data and the like and is typically a secondary storage medium such as a hard disk that is slower than primary storage. It will be appreciated that the information retained within the mass storage device 908, may, in appropriate cases, be incorporated in standard fashion as part of primary storage 906 as virtual memory. A specific mass storage device such as a CD-ROM or DVD-ROM 914 may also pass data uni-directionally to the CPU.

CPU 902 is also coupled to an interface 910 that includes one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 902 optionally may be coupled to a computer or telecommunications network using a network connection as shown generally at 912. With such a network connection, it is contemplated that the CPU might receive information from the network, or might output information to the network in the course of performing the above-described method steps. The above-described devices and materials will be familiar to those of skill in the computer hardware and software arts.

The hardware elements described above may implement the instructions of multiple software modules for performing the operations of this invention. For example, instructions for calculating statistical significance may be stored on mass storage device 908 or 914 and executed on CPU 908 in conjunction with primary memory 906.

In addition, embodiments of the present invention further relate to computer readable media or computer program products that include program instructions and/or data (including data structures) for performing various computer-implemented operations. The media and program instructions may be those specially designed and constructed for the purposes of the present invention, or they may be of the kind well known and available to those having skill in the computer software arts. Examples of computer-readable media include, but are not limited to, magnetic media such as hard disks, floppy disks, and magnetic tape; optical media such as CD-ROM, CDRW, DVD-ROM, or DVD-RW disks; magneto-optical media such as floptical disks; and hardware devices that are specially configured to store and perform program instructions, such as read-only memory devices (ROM) and random access memory (RAM). Examples of program instructions include both machine code, such as produced by a compiler, and files containing higher level code that may be executed by the computer using an interpreter.

While the present invention has been described with reference to the specific embodiments thereof, it should be understood by those skilled in the art that various changes may be made and equivalents may be substituted without departing from the true spirit and scope of the invention. In addition, many modifications may be made to adapt a particular situation, material, composition of matter, process, process step or steps, to the objective, spirit and scope of the present invention. All such modifications are intended to be within the scope of the claims appended hereto.

That which is claimed is:

1. A method for analyzing CGH data, together with data from an independent source, said method comprising the step of:
comparing the independent data with the CGH data, wherein the CGH data is characterized by sets of defined regions, said sets differentiated by at least one property; and
assessing enrichment of at least one subset of the data from an independent source with regard to at least one of said sets of defined regions.

2. The method of claim 1, wherein the sets of defined regions comprise aberrant regions and non-aberrant regions.

3. The method of claim 2, wherein the aberrant regions comprises significantly amplified regions and significantly deleted regions.

4. The method of claim 1 wherein the data from an independent source comprises sequence elements defined by a separate analysis, measurement or source of information.

5. The method of claim 4, wherein the sequence elements include at least one of: genes; genes that have significant differential expression, as measured by an independent study; genes with a specific annotation; and genes related to a clinical condition, as deduced from literature or a database.

6. The method of claim 5, wherein said genes with a specific annotation comprises genes with a GO annotation.

7. The method of claim 4, wherein the sequence elements include at least one of: sequence motifs; miRNA precursors, structure motifs, regulatory elements, TFBS's, sequences determined by homology to another organism, genes with scores for differential expression; sequence locations with affinity signals from ChIP chip assays; and Single Nucleotide Polymorphism (SNP) loci with linkage or association signals in a genetic study.

8. The method of claim 1, further comprising calculating statistical significance of the assessed enrichment.

9. The method of claim 1, further comprising outputting a result of said assessing enrichment.

10. The method of claim 8, further comprising outputting a result of said calculating statistical significance.

11. The method of claim 9, wherein said outputting comprises outputting a visualization of a relationship between at least one of said sets of defined regions and said data from an independent source.

12. The method of claim 11, wherein the visualization plots a fraction of said data from an independent source that occurs within at least one of said sets of defined regions.

13. The method of claim 11, wherein the visualization comprises a GO tree with annotation of enrichment results adjacent each term in the GO tree for which enrichment of the genes associated with that term was assessed.

14. The method of claim 13, wherein each said annotation comprises an array of two indicators, one of said indicators indicating a degree of common amplification of the genes, over all samples considered, with respect to what is represented by the adjacent GO term, and the other of said indicators indicating a degree of common deletion of the genes, over all samples considered, with respect to what is represented by the adjacent GO term.

15. The method of claim 13, wherein each said annotation comprises a vector, with each member of said vector indicating a degree of amplification or deletion, or neutrality, for a sample, with respect to what is represented by the adjacent GO term.

16. The method of claim 13, wherein each said annotation comprises a matrix, wherein each column or row of said matrix comprises two cells, one cell indicating whether or not amplification was found for a sample, with respect to what is represented by the adjacent GO term, and the other cell indicating whether or not deletion was found for the sample, with respect to what is represented by the adjacent GO term, and wherein each row or column, respectively, represents a sample that was analyzed.

17. The method of claim 13, wherein significance values of the enrichment results are annotated in the visualization.

18. The method of claim 13, wherein enrichment results from multiple samples for which CGH data is provided are annotated adjacent each GO term.

19. The method of claim 11, wherein the visualization graphically displays at least one of said sets of defined regions distinctively from an overall plot of the CGH data, and further displays a graphical representation of said at least one subset of the data from an independent source, to indicate where members of said at least one subset of the data from an independent source occur with respect to the CGH data.

20. The method of claim 1, wherein the data from an independent source comprises binary data, and said assessing enrichment comprises calculating a fraction of said at least one subset that resides in said alt least one of said sets of defined regions, calculating a fraction of said at least one subset that resides in a universal set of genes or sequence elements.

21. The method of claim 1, wherein the data from an independent source comprises ordered, quantitative data, and said assessing enrichment comprises identifying where a distribution of said ordered quantitative data in said at least one of said sets of defined regions is different from a distribution of said ordered quantitative data in an entire genome.

22. The method of claim 8, wherein said calculating statistical significance is calculated using a Binomial model.

23. The method of claim 8, wherein said calculating statistical significance is calculated using a hypergeometric model.

24. The method of claim 8, wherein said calculating statistical significance is calculated using false discovery rate assessment.

25. A method of visualizing CGH data as it is impacted by data from an independent source, said method comprising visualizing a relationship between at least one defined set of the CGH data and at least one set of sequence elements defined in said data from an independent source.

26. The method of claim 25, wherein said at least one defined set of the CGH data comprises aberrant regions.

27. The method of claim 25, wherein the visualization plots a fraction of said at lest one set of sequence elements that occurs within at least one of said sets of defined regions.

28. The method of claim 25, wherein the visualization comprises a GO tree with annotation of enrichment results adjacent each term in the GO tree for which enrichment of the genes associated with that term was assessed relative to the at least one of said sets of defined regions.

29. The method of claim 28, wherein significance values of the enrichment results are annotated in the visualization.

30. The method of claim 25, wherein enrichment results from multiple samples for which CGH data is provided are annotated adjacent each GO term.

31. The method of claim 25, wherein the visualization graphically displays at least one of said sets of defined regions distinctively from an overall plot of the CGH data, and further displays a graphical representation of said at least one set of sequence elements, to indicate where members of said at least one set of sequence elements occur with respect to the CGH data.
